(19) United States
(12) Patent Application Publication
(10) Pub. No.: US 2017/0005532 A1
(43) Pub. Date: Jan. 5, 2017

(54) AUTOMATIC MATCHING CIRCUIT FOR HIGH FREQUENCY RECTIFICATION CIRCUIT

(71) Applicant: MITSUBISHI ELECTRIC ENGINEERING COMPANY, LIMITED, Chiyoda-ku (JP)

(72) Inventors: Yoshiyuki AKUZAWA, Chiyoda-ku (JP); Kiyohide SAKAI, Chiyoda-ku (JP); Toshihiro EZOE, Chiyoda-ku (JP); Yuki ITO, Chiyoda-ku (JP)

(73) Assignee: MITSUBISHI ELECTRIC ENGINEERING COMPANY, LIMITED, Chiyoda-ku (JP)

(21) Appl. No.: 15/107,362

(22) PCT Filed: Dec. 26, 2013
(86) PCT No.: PCT/JP2013/084833

§ 371 Date: Jun. 22, 2016

(51) Int. Cl. H02J 50/27; H02M 7/06

(52) U.S. Cl. CPC H02J 50/27; H02M 7/06

(57) ABSTRACT

An automatic matching circuit includes a variable inductor disposed in order to perform impedance matching at a high frequency equal to or higher than 2 MHz between the output. impedance of a resonant type reception antenna 10 and the input impedance of a high frequency rectification circuit 11, to cause an inductance value to be variable by using an electronic part that electrically performs contact switching including continuous contact switching, a variable capacitor disposed in order to perform the impedance matching, to cause a capacitance value to be variable by using an electronic part that electrically performs contact switching including continuous contact switching, and a variable control circuit 1 to control the electronic parts, in the variable inductor and the variable capacitor, each of which electrically performs the contact switching including the continuous contact switching, in such a way as to perform the impedance matching.

### FIELD OF THE INVENTION

The present invention relates to an automatic matching circuit for high frequency rectification circuit that automatically adjusts the impedance matching between the output impedance of a reception antenna for power transmission and the input impedance of a high frequency rectification circuit

### BACKGROUND OF THE INVENTION

Conventionally, a matching circuit is disposed in order to adjust the impedance matching between a power supply on an input side and a primary coil (transmission antenna) on an output side (for example, refer to patent reference 1). In this matching circuit, the adjustable range of the impedance matching is extended by using a variable inductor that causes its inductance value to be variable by using contact switching which employs a switch, and a variable capacitor that causes its capacitance value to be variable by using contact switching which employs a switch.

### RELATED ART DOCUMENT

### Patent Reference

Patent reference 1: Japanese Unexamined Patent Application Publication No. 2013-5614

### SUMMARY OF THE INVENTION

### Problems to be Solved by the Invention

However, because the variable capacitor and the variable inductor in the conventional configuration are based on elements which have been known conventionally, the matching circuit has an element structure having mechanical contacts. Therefore, a problem is that the life of the elements is short because of the wearing away of the mechanical contacts, and this short life limits the life of the system. A further problem is that because switching of the constants cannot be performed at a high speed, the startup speed of the system is slow. A still further problem is that when switching of the constants is performed in an energized state, electric discharge occurs in the mechanical contacts within the elements, and this results in induction of component failures due to melting, welding, carbonization, high voltage noise, or the like.

Further, in the conventional configuration, a case in which the input impedance of the transmission antenna varies is not assumed. Therefore, a problem is that effective impedance matching cannot be achieved for a moving object in which the distance between a transmission antenna and a reception antenna in a wireless power transmission system is varied.

The present invention is made in order to solve the above-mentioned problems, and it is therefore an object of the present invention to provide an automatic matching circuit for high frequency rectification circuit that can automatically adjust the impedance matching between the output impedance of a reception antenna for power transmission and the input impedance of a high frequency rectification circuit by using elements each not having a mechanical contact.

### Means for Solving the Problem

According to the present invention, there is provided an automatic matching circuit for high frequency rectification circuit, the automatic matching circuit including: a variable inductor disposed in order to perform impedance matching at a high frequency equal to or higher than 2 MHz between the output impedance of a reception antenna for power transmission and the input impedance of a high frequency rectification circuit, to cause an inductance value to be variable by using an electronic part that electrically performs contact switching including continuous contact switching; a variable capacitor disposed in order to perform the impedance matching, to cause a capacitance value to be variable by using an electronic part that electrically performs contact switching including continuous contact switching; and a variable control circuit to control the electronic parts in the variable inductor and the variable capacitor, each of which electrically performs the contact switching including the continuous contact switching, in such a way as to perform the impedance matching.

### Advantages of the Invention

Because the automatic matching circuit for high frequency rectification circuit according to the present invention is configured as above, the automatic matching circuit for high frequency rectification circuit can automatically adjust the impedance matching between the output impedance of the reception antenna for power transmission and the input impedance of the high frequency rectification circuit by using the elements each not having a mechanical contact.

### BRIEF DESCRIPTION OF THE FIGURES

FIG. 1 is a diagram showing the configuration of an automatic matching circuit for high frequency rectification circuit according to Embodiment 1 of the present invention;

FIG. 2 is a diagram showing the configuration of a variable inductor in Embodiment 1 of the present invention;

FIG. 3 is a diagram showing another example of the configuration of the variable inductor in Embodiment 1 of the present invention;

FIG. 4 is a diagram showing another example of the configuration of the variable inductor in Embodiment 1 of the present invention;

FIG. 5 is a diagram showing the configuration of each of variable capacitors in Embodiment 1 of the present invention; and

FIG. 6 is a diagram showing the configuration of a high frequency rectification circuit connected to the automatic matching circuit for high frequency rectification circuit according to Embodiment 1 of the present invention;

FIG. 7 is a diagram showing another example of the configuration of the high frequency rectification circuit connected to the automatic matching circuit for high frequency rectification circuit according to Embodiment 1 of the present invention;

FIG. 8 is a diagram showing another example of the configuration of the high frequency rectification circuit connected to the automatic matching circuit for high frequency rectification circuit according to Embodiment 1 of the present invention;

FIG. 9 is a diagram showing another example of the configuration of the high frequency rectification circuit connected to the automatic matching circuit for high frequency rectification circuit according to Embodiment 1 of the present invention;

FIG. 10 is a diagram showing another example of the configuration of the high frequency rectification circuit connected to the automatic matching circuit for high frequency rectification circuit according to Embodiment 1 of the present invention; and

FIG. 11 is a diagram showing another example of the configuration of the automatic matching circuit for high frequency rectification circuit according to Embodiment 1 of the present invention.

### EMBODIMENTS OF THE INVENTION

Hereafter, the preferred embodiments of the present invention will be explained in detail with reference to the drawings.

### Embodiment

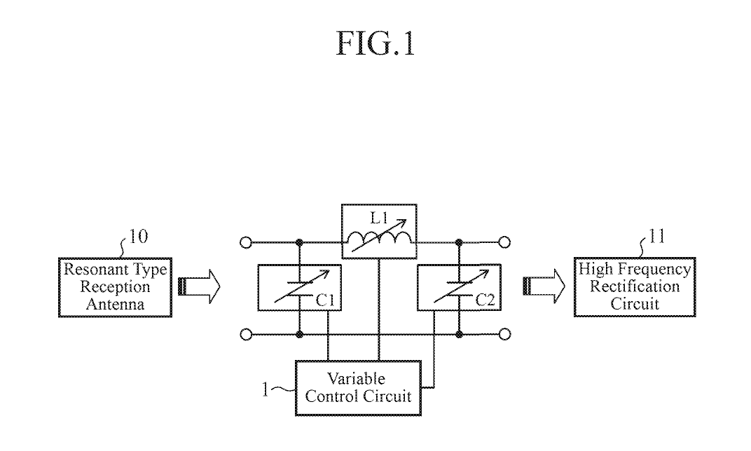

FIG. 1 is a diagram showing the configuration of an automatic matching circuit for high frequency rectification circuit according to Embodiment 1 of the present invention.

The automatic matching circuit for high frequency rectification circuit automatically adjusts the impedance matching at a high frequency equal to or higher than 2 MHz between the output impedance of a resonant type reception antenna (reception antenna for power transmission) 10 and the input impedance of a high frequency rectification circuit 11. This automatic matching circuit for high frequency rectification circuit is configured with a variable inductor L1, variable capacitors C1 and C2, and a variable control circuit 1, as shown in FIG. 1.

Further, the resonant type reception antenna 10 is a resonance type antenna having an LC resonance characteristic for power transmission (the antenna is not limited only to a one of noncontact type). This resonant type reception antenna 10 can be of any of magnetic-field resonance type, electric-field resonance type, and electromagnetic induction type. Further, the high frequency rectification circuit 11 rectifies an alternating voltage at a high frequency exceeding 2 MHz.

The variable inductor L1 is an element for performing the impedance matching at a high frequency equal to or higher than 2 MHz between the output impedance of the resonant type reception antenna 10 and the input impedance of the high frequency rectification circuit 11. This variable inductor L1 is configured in such a way as to be able to vary its inductance value (L value) under control by the variable control circuit 1 by using an electronic part that electrically performs contact switching including continuous contact switching. More specifically, the variable inductor L1 is an element that does not have any mechanical contact as a component for causing the inductance value to be variable. The details of this variable inductor L1 will be described below.

The variable capacitors C1 and C2 are elements each for performing the impedance matching at a high frequency equal to or higher than 2 MHz between the output impedance of the resonant type reception antenna 10 and the input impedance of the high frequency rectification circuit 11. Each of these variable capacitors C1 and C2 is configured in such a way as to be able to vary its capacitance value under control by the variable control circuit 1 by using an electronic part that electrically performs contact switching including continuous contact switching. More specifically, each of the variable capacitors C1 and C2 is an element that does not have any mechanical contact as a component for causing the capacitance value to be variable. The details of these variable capacitors C1 and C2 will be described below.

The variable control circuit 1 controls the electronic parts, in the variable inductor L1 and the variable capacitors C1 and C2, each of which electrically performs the contact switching including the continuous contact switching, in such a way as to perform the impedance matching at a high frequency equal to or higher than 2 MHz between the output impedance of the resonant type reception antenna 10 and the input impedance of the high frequency rectification circuit 11. More specifically, by using this variable control circuit 1, the automatic matching circuit for high frequency rectification circuit causes the inductance value of the variable inductor L1 and the capacitance values of the variable capacitors C1 and C2 to be variable, thereby adjusting the impedance matching automatically. This variable control circuit 1 is configured in such a way that the variable control circuit is implemented by either program execution based on software and using a CPU, or feedback control using a detection signal according to a voltage and a current superposed onto the resonant type reception antenna 10.

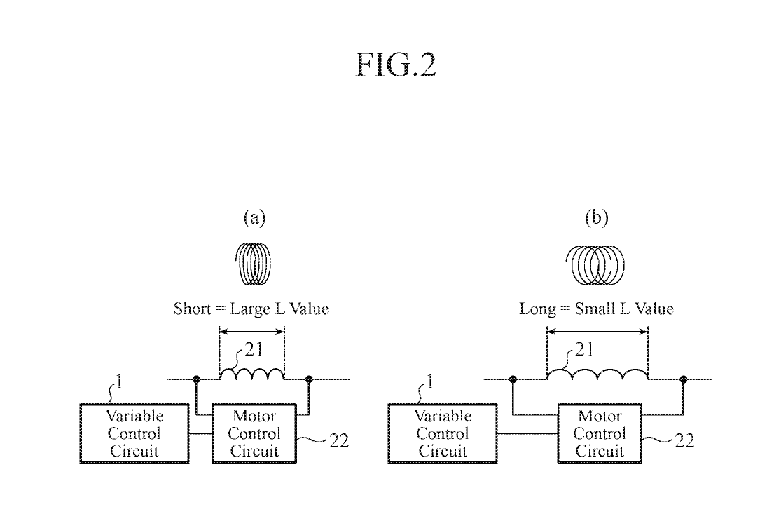

Next, examples of the configuration of the variable inductor L1 will be explained by referring to FIGS. 2 to 4.

In the examples of FIG. 2, a motor control circuit used as the electronic part that electrically performs the contact switching including the continuous contact switching, and the variable inductor L1 is of a type of automatically causing the magnetic path length of a coil 21 to be variable by using this motor control circuit 22. In this configuration, the automatic matching circuit for high frequency rectification circuit causes the inductance value to be variable by driving the motor control circuit 22 by using the variable control circuit 1 to cause the magnetic path length of the coil 21 to be physically variable. In the examples of FIGS. 2(a) and 2(b) the number of turns of the coil 21 is the same.

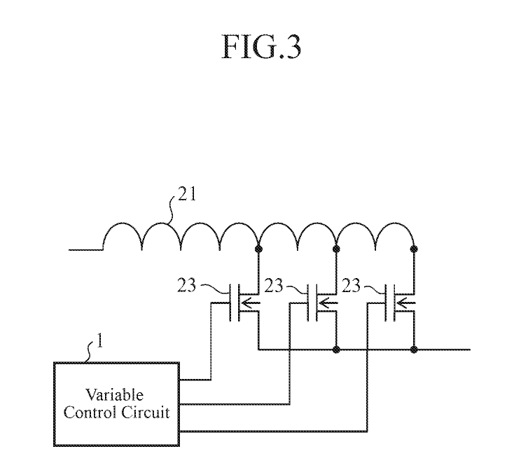

Further, in the example of FIG. 3, field effect transistors (FETs) 23 are used as the electronic part that electrically performs the contact switching including the continuous contact switching, and the variable inductor L1 is of a type of automatically adjusting the number of turns of the coil 21 by using these FETs 23. In this configuration, one FET 23 is connected to each point of the coil having a certain number of turns, and switching between ON and OFF of each of the FETs 23 is performed by the variable control circuit 1 or switching of pulse width modulation (PWM) or the like is performed by the variable control circuit 1 so as to cause the number of turns of the coil 21 to be variable, thereby causing the inductance value to be variable. The FETs 23 are elements, such as Si-MOSFETs, SiC-MOSFETs, GaN-FETs or FETs for RF (Radio Frequency), or are configured into a body diode of off type in which such elements are connected in series.

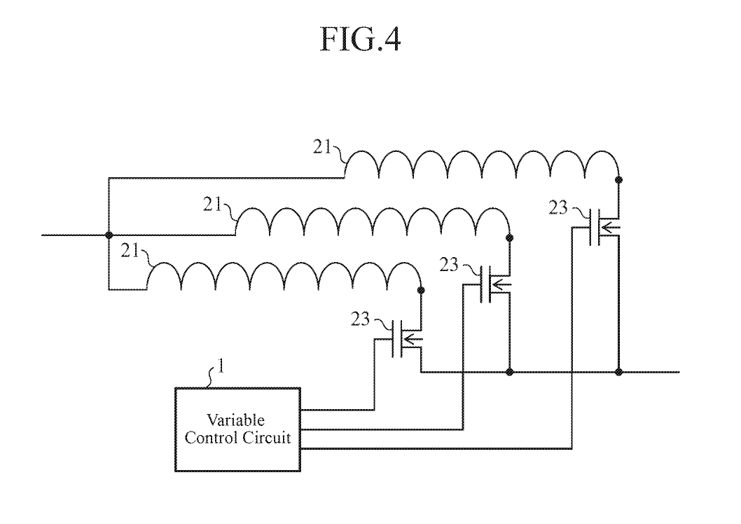

Further, in the example of FIG. 4, FETs 23 are used as the electronic part that electrically performs the contact switching including the continuous contact switching, and the variable inductor L1 is of a type of automatically causing the number of coils 21 connected in parallel to be variable by using these FETs 23. In this configuration, one FET 23 is connected to each of the coils 21 connected in parallel, and switching between ON and OFF of each of the FETs 23 is performed by the variable control circuit 1, or switching of pulse width modulation (PWM) or the like is performed by the variable control circuit 1 so as to cause the number of coils 21 connected in parallel to be variable, thereby causing the inductance value to be variable. The FETs 23 are elements, such as Si-MOSFETs, SiC-MOSFETs, GaN-FETs or FETs for RF, or are configured into a body diode of off type in which such elements are connected in series.

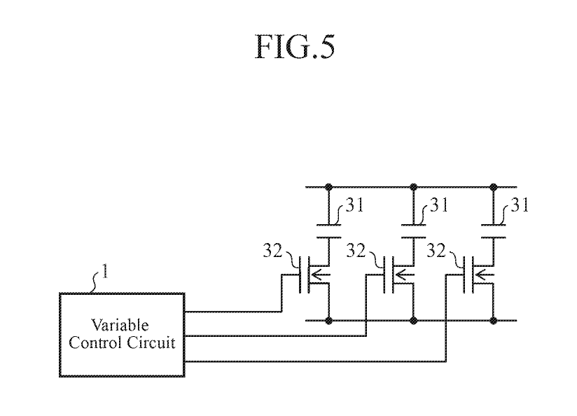

Next, an example of the configuration of each of the variable capacitors C1 and C2 will be explained by referring to FIG. 5.

In the example of FIG. 5, FETs 32 are used as the electronic part that electrically performs the contact switching including the continuous contact switching, and each of the variable number of capacitors 31 connected in parallel to be variable by using these FETs 32. In this configuration, one FET 32 is connected to each of the capacitors 31 connected in parallel, and switching between ON and OFF of each of the FETs 32 is performed by the variable control circuit 1, or switching of pulse width modulation (PWM) or the like is performed by the variable control circuit 1 so as to cause the number of capacitors 31 connected in parallel to be variable, thereby causing the capacitance value to be variable. The FETs 32 are elements, such as Si-MOSFETs, SiC-MOSFETs, GaN-FETs or FETs for RF, or are configured into a body diode of off type in which such elements are connected in series.

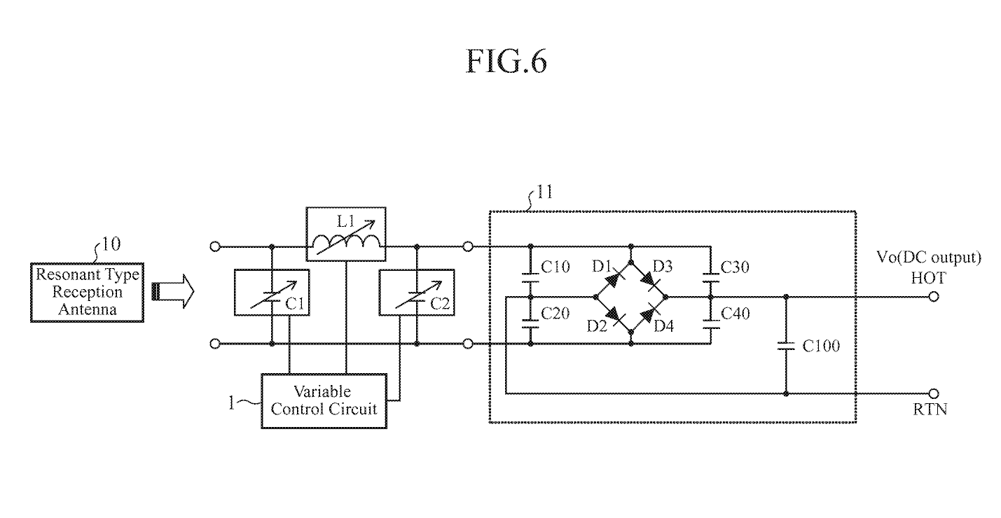

Next, the configuration of the high frequency rectification circuit 11 connected to the automatic matching circuit for high frequency rectification circuit will be explained by referring to FIGS. 6 to 10.

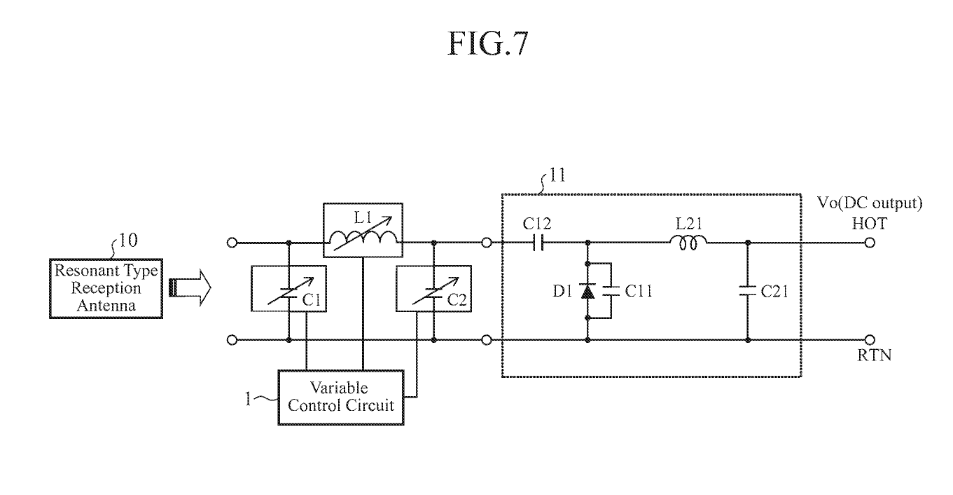

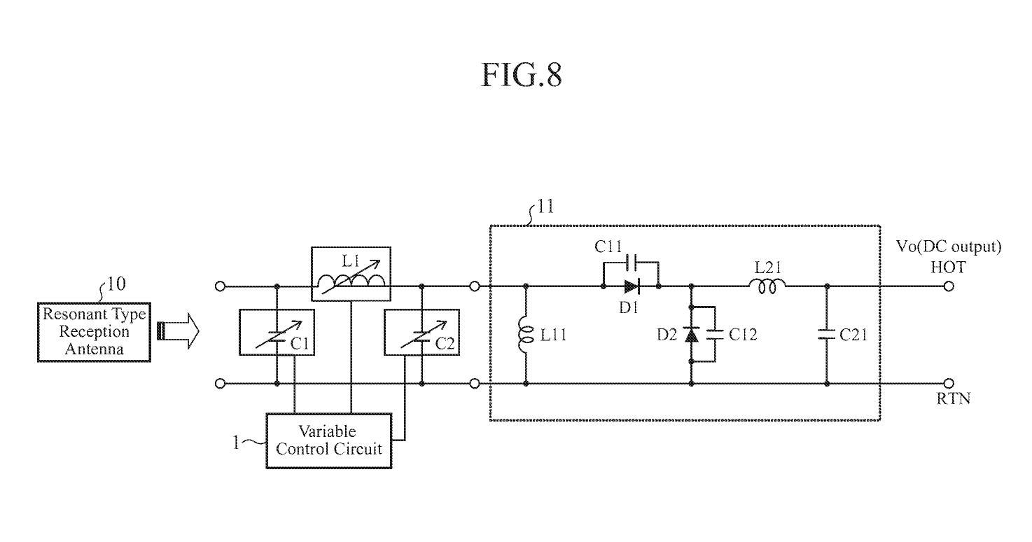

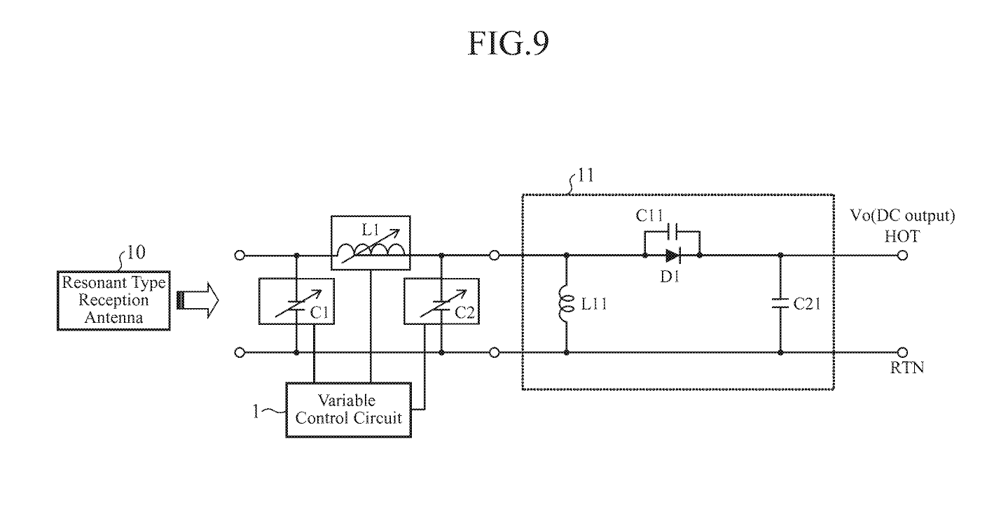

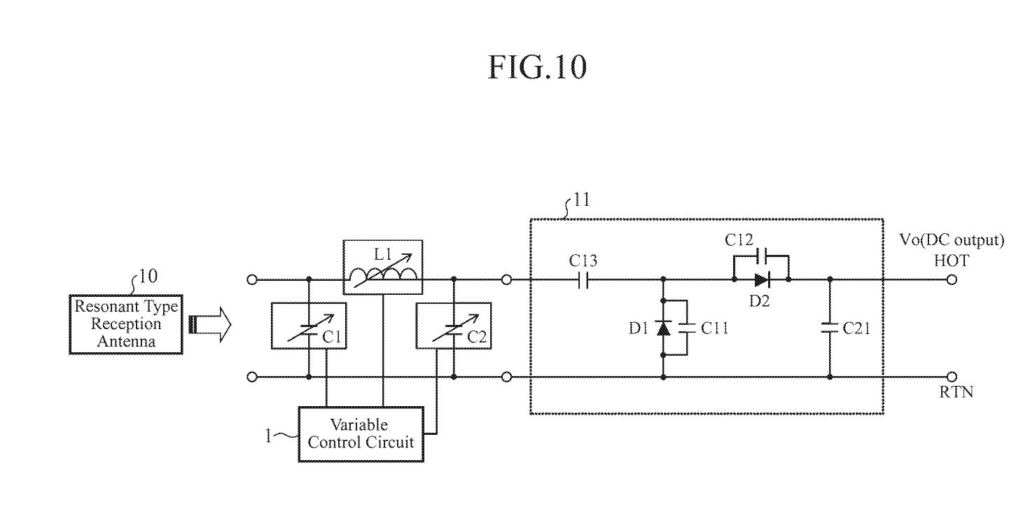

FIG. 6 shows an example in which a bridge rectifier circuit is connected as the high frequency rectification circuit 11. Further, FIG. 7 shows an example in which a class-E rectifier circuit is connected as the high frequency rectification circuit 11. Further, FIG. 8 shows an example in which a current doubler rectifier circuit is connected as the high frequency rectification circuit 11. Further, FIG. 9 shows an example in which a half wave rectifier circuit is connected as the high frequency rectification circuit 11. Further, FIG. 10 shows an example in which a voltage doubler rectifier circuit is connected as the high frequency rectification circuit 11.

As mentioned above, because the automatic matching circuit for high frequency rectification circuit according to this Embodiment 1 includes the variable inductor L1 that causes its inductance value to be variable by using an electronic part that electrically performs contact switching including continuous contact switching, the variable capacitors C1 and C2 each of that causes its capacitance value to be variable by using an electronic part that electrically performs contact switching including continuous contact switching, and the variable control circuit 1 that controls the electronic parts, in the variable inductor L1 and the variable capacitors C1 and C2, each of which electrically performs the contact switching including the continuous contact switching, in such a way as to perform the impedance matching at a high frequency equal to or higher than 2 MHz between the output impedance of the resonant type reception antenna 10 and the input impedance of the high frequency rectification circuit 11, the automatic matching circuit for high frequency rectification circuit can adjust the above-mentioned impedance matching automatically by using the elements each not having a mechanical contact, and can be configured at a low cost and in a small size and can perform reliable operations. As a result, the automatic matching circuit for high frequency rectification circuit can automatically achieve effective impedance matching also for a moving object in which the distance between a transmission coil (transmission antenna) which is a device on a transmit side in a wireless power transmission system and a reception coil (reception antenna) which is a device on a receive side in the wireless power transmission system is varied.

Further, because the automatic matching circuit for high frequency rectification circuit has the circuit configuration in which the elements each not having a mechanical contact are disposed, no mechanical wear occurs in the elements and such restrictions as conventionally imposed on the service life can be eliminated. Further, switching of the constants can be performed at a high speed, and the system startup can be speeded up. Further, because switching of the constants can be performed in an energized state, and no electric discharge or the like occurs in the elements at that time, no component failures are induced.

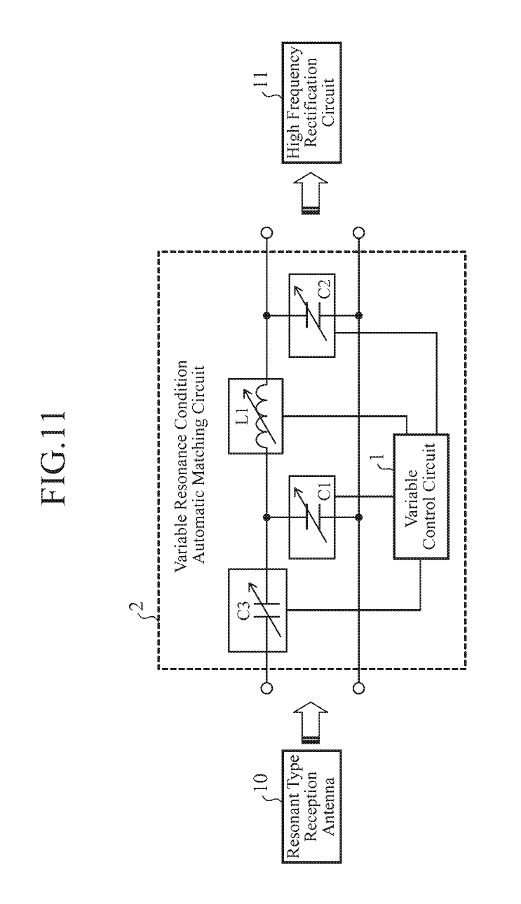

As shown in FIG. 11, a variable capacitor C3 can be added to the configuration shown in FIG. 1, and a variable resonance condition automatic matching circuit that causes the inductance value of the variable inductor L1 and the capacitance values of the variable capacitors C1, C2 and C3 to be variable by using the variable control circuit 1, thereby causing the resonance condition of the resonant type reception antenna 10 to be variable can be disposed. The variable capacitor C3 has the same configuration as the variable capacitors C1 and C2. Further, some elements can be added to or eliminated from the configuration shown in FIG. 11.

Further, while the invention has been described in its preferred embodiment, it is to be understood that various changes can be made in an arbitrary component according to the embodiment, and an arbitrary component according to the embodiment can be omitted within the scope of the invention.

### Industrial Applicability

The automatic matching circuit for high frequency rectification circuit according to the present invention can automatically adjust the impedance matching between the output impedance of the reception antenna for power transmission and the input impedance of the high frequency rectification circuit by using elements each not having a mechanical contact, and is suitable for use as an automatic matching circuit for high frequency rectification circuit t or the like that adjust impedance matching.

### Explanations of Reference Numerals

1 variable control circuit, 10 resonant type reception antenna, 11 high frequency rectification circuit, 21 coil, 22 motor control circuit, 23 FET, 31 capacitor, and 32 FET.

1. An automatic matching circuit for high frequency rectification circuit, automatic matching circuit comprising:
a variable inductor disposed in order to perform impedance matching at a high frequency equal to or higher than 2 MHz between an output impedance of a reception antenna for power transmission and an input impedance of a high frequency rectification circuit, to cause an inductance value to be variable by using an electronic part that electrically performs contact switching including continuous contact switching;
a variable capacitor disposed in order to perform said impedance matching, to cause a capacitance value to be variable by using an electronic part that electrically performs contact switching including continuous contact switching; and
a variable control circuit to control the electronic parts, said variable inductor and said variable capacitor, each of which electrically performs the contact switching including the continuous contact switching, in such a way as to perform said impedance matching.

2. The automatic matching circuit for high frequency rectification circuit according to claim 1, wherein said variable control circuit causes a resonance condition of said reception antenna for power transmission according to magnetic-field resonance to be variable.

3. The automatic matching circuit for high frequency rectification circuit according to claim 1, wherein said variable control circuit causes a resonance condition of said reception antenna for power transmission according to electric-field resonance to be variable.

4. The automatic matching circuit for high frequency rectification circuit according to claim 1, wherein said variable control circuit causes a resonance condition of said reception antenna for power transmission according to electromagnetic induction to be variable.
